(19) United States
(12) Patent Application Publication
(10) Pub. No.: US 2026/0128933 A1
(43) Pub. Date: May 7, 2026

(54) LOW-COST LOW-COMPLEXITY WIRELESS TRANSMISSION METHOD AND APPARATUS

(71) Applicant: ELECTRONICS AND TELECOMMUNICATIONS RESEARCH INSTITUTE, Daejeon (KR)

(72) Inventors: Kapseok CHANG, Daejeon (KR); Kyeongpyo KIM, Daejeon (KR); Wooram SHIN, Daejeon (KR); Young Jo KO, Daejeon (KR); Yong Sun KIM, Daejeon (KR); Woncheol CHO, Daejeon (KR)

(21) Appl. No.: 19/379,358

(22) Filed: Nov. 4, 2025

(30) Foreign Application Priority Data
Nov. 5, 2024 (KR) 10-2024-0155262
Nov. 3, 2025 (KR) 10-2025-0163271

(51) Int. Cl. H04L 27/20; H04L 25/08

(52) U.S. Cl. CPC H04L 27/20; H04L 25/08

(57) ABSTRACT

A signal transmission method may comprise: generating a first symbol sequence from a source bit sequence; performing phase distortion-resistant (PR) encoding on the first symbol sequence to generate a second symbol sequence; performing real-to-phase converting on the second symbol sequence to generate a third symbol sequence; performing repetitive single carrier (RSC) encoding on the third symbol sequence to generate a fourth symbol sequence; and performing baseband filtering on the fourth symbol sequence and transmitting the baseband-filtered fourth symbol sequence over a wireless channel.

### CROSS-REFERENCE TO RELATED APPLICATIONS

This application claims priority to Korean Patent Applications No. 10-2024-0155262, filed on Nov. 5, 2024, and No. 10-2025-0163271, filed on Nov. 3, 2025, with the Korean Intellectual Property Office (KIPO), the entire contents of which are hereby incorporated by reference.

### BACKGROUND

### 1. Technical Field

The present disclosure relates to a wireless transmission technique, and more particularly, to a low-cost low-complexity wireless transmission method and an apparatus therefor that provide a wide communication coverage while exhibiting robustness against phase distortions caused by hardware impairments, Doppler shifts, and the like.

### 2. Related Art

Powering every Internet-of-Things (IoT) device that requires battery replacement or manual recharging may be impractical or infeasible, which leads to high maintenance costs and serious environmental issues. The automation and digitalization of various industries are creating new markets that demand battery-less and power-free IoT devices without energy storage, eliminating the need for manual replacement or charging. Power-free IoT devices refer to devices that harvest energy from surrounding sources such as radio waves, light, motion, heat, or other suitable power sources. Barcodes and radio-frequency identification (RFID) tags, which are currently used in most industries, can be considered ultra-small, battery-less, power-free IoT devices featuring low cost and low complexity. However, such conventional power-free IoT devices require passive scanning despite having a limited reading range of only a few meters, resulting in labor-intensive and time-consuming operations.

Accordingly, starting from 2024, the 3rd Generation Partnership Project (3GPP) Release 19 has initiated a new Study Item (SI) named Ambient IoT (“AIoT”), which aims to enable cellular systems to automatically manage tens to hundreds of power-free IoT devices over an extended reading range of 10 to 50 meters.

### SUMMARY

The present disclosure for resolving the above-described problems is directed to providing a wireless transmission method and apparatus that are robust against phase distortions while being low-cost and low-complexity.

According to a first exemplary embodiment of the present disclosure, a signal transmission method may comprise: generating a first symbol sequence from a source bit sequence; performing phase distortion-resistant (PR) encoding on the first symbol sequence to generate a second symbol sequence; performing real-to-phase converting on the second symbol sequence to generate a third symbol sequence; performing repetitive single carrier (RSC) encoding on the third symbol sequence to generate a fourth symbol sequence; and performing baseband filtering on the fourth symbol sequence and transmitting the baseband-filtered fourth symbol sequence over a wireless channel.

The generating of the first symbol sequence may comprise: mapping each bit of the source bit sequence to an integer value of −1 or 1 such that absolute magnitudes of symbols of the first symbol sequence are identical.

The PR encoding may be expressed by:

$${q}_{t} ( n ) = m π {\sum }_{{n}^{′} = 0}^{n} {x}^{⌣} ( {n}^{′} ) , 0 \leq n < N$$

wherein the first symbol sequence is x̆(n), the second symbol sequence is qₜ(n), m denotes a scaling factor to form qₜ(n) within [−π, π), and N denotes a number of symbols included in the first symbol sequence.

The real-to-phase converting may be expressed by:

$$\tilde{x} ( n ) = {e}^{j {q}_{t} ( n )} , 0 \leq n < N$$

wherein the third symbol sequence is \tilde{x}(n).

The RSC encoding may be expressed by:

$${x}_{n} = \{ \begin{matrix}{e}^{j ( {ϕ}_{{d}_{⌊ \frac{n}{A} ⌋}} )} , & even n = 0 , 2 , … , NA - 2 \\ {e}^{j ( - {ϕ}_{{d}_{⌊ \frac{n}{A} ⌋}} )} , & odd n = 1 , 3 , … , NA - 1\end{matrix}$$

where the fourth symbol sequence is xₙ, φ_{z} denotes a phase component of a time-domain signal z, N denotes a number of symbols included in the fourth symbol sequence, and A denotes a repetition factor.

According to a second exemplary embodiment of the present disclosure, a signal reception method may comprise: performing baseband filtering on a received signal to generate a first symbol sequence; performing repetitive single carrier (RSC) de-mapping on the first symbol sequence to generate a second symbol sequence; performing time-to-phase converting on the second symbol sequence to generate a third symbol sequence; performing phase distortion-resistant (PR) decoding on the third symbol sequence to generate a fourth symbol sequence; and generating a restored source bit sequence from the fourth symbol sequence.

The signal reception method may further comprise: performing time-to-frequency converting, frequency-domain equalizing, and frequency-to-time converting on the first symbol sequence.

The first symbol sequence may be expressed as a time-domain signal according to:

$${y}_{n} = {w}_{n} + \sqrt{P} {α}_{{h}_{n}} \{ \begin{matrix}{e}^{j ( {ϕ}_{{d}_{⌊ \frac{n}{A} ⌋}} + {ϕ}_{{h}_{n}} + {ϕ}_{{ϵ}_{n}} )} , & even n = 0 , 2 , … , NA - 2 \\ {e}^{j ( - {ϕ}_{{d}_{⌊ \frac{n}{A} ⌋}} + {ϕ}_{{h}_{n}} + {ϕ}_{{ϵ}_{n}} )} , & odd n = 1 , 3 , … , NA - 1\end{matrix}$$

where P denotes A received power, φ_{z} denotes a phase component of a time-domain signal z, α_{z} denotes an amplitude component of the signal z, hₙ denotes a wireless fading channel, ϵₙ denotes a carrier frequency offset (CFO), wₙ denotes noise, N denotes a number of symbols included in the second symbol sequence, and A denotes a repetition factor.

The RSC de-mapping may be expressed by:

$${\breve{y}}_{{n}^{′}} = {( {y}_{2 {n}^{′} + 1} )}^{*} + {y}_{2 {n}^{′}} = ( {w}_{2 {n}^{′} + 1}^{*} + {w}_{2 {n}^{′}} ) + \sqrt{P} ( \begin{matrix}{α}_{{h}_{2 {n}^{′} + 1}} {e}^{j ( - {ϕ}_{{h}_{2 {n}^{′} + 1}} - {ϕ}_{{ϵ}_{2 {n}^{′} + 1}} )} + \\ {α}_{{h}_{2 {n}^{′}}} {e}^{j ( - {ϕ}_{{h}_{2 {n}^{′}}} - {ϕ}_{{ϵ}_{2 {n}^{′}}} )}\end{matrix} ) {e}^{j ( {ϕ}_{{d}_{⌊ \frac{2 {n}^{′}}{A} ⌋}} )} ,$$

$${n}^{′} = 0 , 1 , … , ⌊ \frac{N A - 1}{2} ⌋$$

where y̆(n′) is the second symbol sequence, and y* denotes a complex conjugate of y in which a real part remains unchanged and an imaginary part is polarity-reversed.

The second symbol sequence may be approximated as:

$${\breve{y}}_{{n}^{′}} \approx \sqrt{P} {α}_{{h}_{2 {n}^{′}}} cos ( {ϕ}_{{h}_{2 {n}^{′}}} + {ϕ}_{{ϵ}_{2 {n}^{′}}} ) exp \{ j ( {ϕ}_{{d}_{⌊ \frac{2 {n}^{′}}{A} ⌋}} ) + ( {w}_{2 {n}^{′} + 1}^{*} + {w}_{2 {n}^{′}} )$$

under assumptions of αₕ_{_{2n′+1}}≈αₕ_{_{2n′}}, φₕ_{_{2n′+1}}≈φₕ_{_{2n′+1}}, φ_{ϵ}_{_{2n′+1}}≈φ_{ϵ}_{_{2n′}}.

A symbol sequence from which repetition has been removed in the second symbol sequence may be expressed by:

$${\tilde{y}}_{{n}^{″}} = \frac{1}{A} {{\sum }_{a = 0}}^{⌊ \frac{A}{2} ⌋ + a} {\breve{y}}_{{n}^{″} ⌊ \frac{A}{2} ⌋ + a} \approx \sqrt{P} {α}_{{h}_{{n}^{″}}} cos ( {ϕ}_{{h}_{{n}^{″}}} + {ϕ}_{{ϵ}_{{n}^{″}}} ) {e}^{j ( {ϕ}_{{d}_{{n}^{″}}} )} , {n}^{″} = 0 , 1 , … , N - 1$$

$${\hat{y}}_{{n}^{″}} = {tan}^{- 1} {\tilde{y}}_{{n}^{″}} or atan 2 ( i mag ( {\tilde{y}}_{{n}^{″}} ) , real ( {\tilde{y}}_{{n}^{″}} ) )$$

wherein imag(\tilde{y}(n″)) and real(\tilde{y}(n″)) respectively denote imaginary and real components of ŷ(n″).

The PR decoding process may be expressed by:

$$\begin{matrix}\begin{matrix}{\hat{q}}_{t} ( n ) = ( {\hat{y}}_{{n}^{′′}} - {\hat{y}}_{{( n - 1 )}^{′′}} ) , & 0 \leq n < N\end{matrix} \\ {\hat{y}}_{{( - 1 )}^{′′}} = 0 \\ \hat{\breve{x}} ( n ) = \frac{1}{m π} {\hat{q}}_{t} ( n )\end{matrix}$$

wherein the fourth symbol sequence is \hat{x}(n).

The generating of the restored source bit sequence may comprise: mapping each symbol of the fourth symbol sequence to a bit value 1 or 0.

According to a third exemplary embodiment of the present disclosure, a signal transmission apparatus may comprise at least one processor, wherein the at least one processor may cause the signal transmission apparatus to perform: generating a first symbol sequence from a source bit sequence; performing phase distortion-resistant (PR) encoding on the first symbol sequence to generate a second symbol sequence; performing real-to-phase converting on the second symbol sequence to generate a third symbol sequence; performing repetitive single carrier (RSC) encoding on the third symbol sequence to generate a fourth symbol sequence; and performing baseband filtering on the fourth symbol sequence and transmitting the baseband-filtered fourth symbol sequence over a wireless channel.

In the generating of the first symbol sequence, each bit of the source bit sequence may be mapped to an integer value of −1 or 1 such that absolute magnitudes of symbols of the first symbol sequence are identical.

The PR encoding may be expressed by:

$${q}_{t} ( n ) = m π {\sum }_{{n}^{′} = 0}^{n} \breve{x} ( {n}^{′} ) , \qquad 0 \leq n < N$$

wherein the first symbol sequence is x̆(n), the second symbol sequence is qₜ(n), m denotes a scaling factor to form qₜ(n) within [−π, π), and N denotes a number of symbols included in the first symbol sequence.

The real-to-phase converting may be expressed by:

$$\tilde{x} ( n ) = {e}^{j {q}_{t} ( n )} , 0 \leq n < N$$

wherein the third symbol sequence is \tilde{x}(n).

The RSC encoding may be expressed by:

$${x}_{n} = \{ \begin{matrix}{e}^{j ( {ϕ}_{{d}_{⌊ \frac{n}{A} ⌋}} )} , & even n = 0 , 2 , … , NA - 2 \\ {e}^{j ( - {ϕ}_{{d}_{⌊ \frac{n}{A} ⌋}} )} , & odd n = 1 , 3 , … , NA - 1\end{matrix}$$

where the fourth symbol sequence is xₙ, φ_{z} denotes a phase component of a time-domain signal z, N denotes a number of symbols included in the fourth symbol sequence, and A denotes a repetition factor.

According to exemplary embodiments of the present disclosure, a low-cost and low-complexity wireless transmission method and communication apparatus can be provided, which offer a wide communication range while exhibiting strong robustness against phase distortions caused by hardware impairments, Doppler shifts, and the like.

### BRIEF DESCRIPTION OF DRAWINGS

FIG. 1 is a conceptual diagram illustrating exemplary embodiments of a communication system.

FIG. 2 is a block diagram illustrating exemplary embodiments of an apparatus.

FIGS. 3A and 3B are conceptual diagrams illustrating two types of AIoT topologies being discussed in 3GPP.

FIG. 4 is a graph comparing block error rate (BER) performances of the conventional transmission schemes and the PR-SC transmission scheme without channel coding/estimation.

FIG. 5 is a block diagram illustrating a PR-RSC transmission scheme according to an exemplary embodiment of the present disclosure.

FIG. 6 is a conceptual diagram illustrating 2-BASK modulation according to an exemplary embodiment of the present disclosure.

FIG. 7 is a conceptual diagram illustrating RSC encoding applied to the PR-RSC transmission method of the present disclosure.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g. Long-Term Evolution (LTE) communication system or LTE-A communication system), the fifth generation (5G) communication system (e.g. New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g. transmission operation)’ may mean ‘signaling of configuration information (e.g. information element(s), parameter(s)) for the operation’ and/or ‘signaling of information indicating performing of the operation’. In other words, ‘an operation (e.g. transmission operation) being configured in a communication node’ may mean that the communication node receives ‘configuration information (e.g. information element, parameter) for the operation’ and/or ‘information indicating to perform the operation’. ‘An information element (e.g. parameter) being configured in a communication node’ may mean that the information element is signaled to the communication node (e.g. the communication node receives the information element)′. Signaling may be at least one of system information (SI) signaling (e.g. transmission of a system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)). A message for SI signaling may be referred to as an SI message, a message for RRC signaling may be referred to as an RRC message, a message for MAC CE signaling may be referred to as a MAC message, and a message for PHY signaling may be referred to as a PHY message. The above-mentioned messages may be expressed as a first message, a second message, a third message, and so on.

In the present disclosure, an expression including “when ˜” may be expressed as an expression including “based on ˜” or an expression including “in response to ˜”. In other words, an expression including “when ˜” may be interpreted as being identical or similar to an expression including “based on ˜” or an expression including “in response to ˜”.

In the present disclosure, a ‘time’ may mean a time point, and ‘time’ and ‘time point’ may be used with the same meaning. A reception time of a signal or channel may mean a reception start time or a reception end time. A transmission time of a signal or channel may mean a transmission start time or a transmission end time.

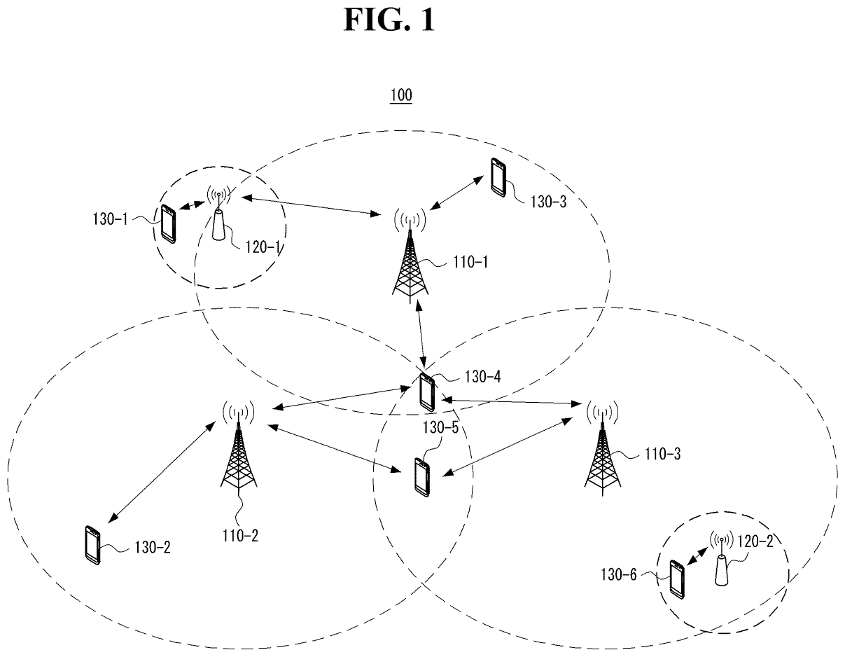

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specificationss (e.g. LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

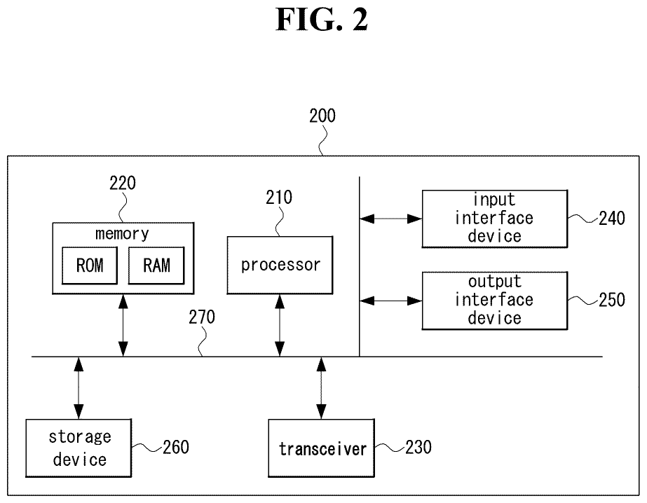

FIG. 2 is a block diagram illustrating exemplary embodiments of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g. single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, exemplary embodiments according to the present disclosure are described. In exemplary embodiments, even when a method (e.g. transmission or reception of a signal) performed at a first communication node among communication nodes is described, a second communication node corresponding thereto may perform a method (e.g. reception or transmission of the signal) corresponding to the method performed at the first communication node. That is, when an operation of a UE is described, a base station corresponding thereto may perform an operation corresponding to the operation of the UE. Conversely, when an operation of a base station is described, a UE corresponding thereto may perform an operation corresponding to the operation of the base station.

Powering all IoT devices that require battery replacement or manual charging may be impractical, which may cause high maintenance costs and serious environmental problems. Automation and digitalization of various industries are creating new markets, and may require battery-less power-free IoT devices without an energy storage function that do not require manual replacement or charging. A power-free IoT device may denote a device that harvests energy from surrounding radio waves, light, motion, heat, or other suitable power sources and uses the harvested energy as power. Barcodes and radio-frequency identification (RFID) tags, which are used in most industries, may be considered ultra-small battery-less and low-cost, low-complexity power-free IoT devices. However, although such conventional power-free IoT devices have a limited reading range of several meters, passive scanning may be required, which may lead to labor-intensive and time-consuming operations.

Accordingly, from 2024, in the 3GPP Rel-19 standard newly initiated, a Study Item (SI) named Ambient IoT (hereinafter referred to as “AIoT”) is in progress to automatically manage tens to hundreds of power-free IoT devices by a mobile communication system in a wide reading range of 10 to 50 m.

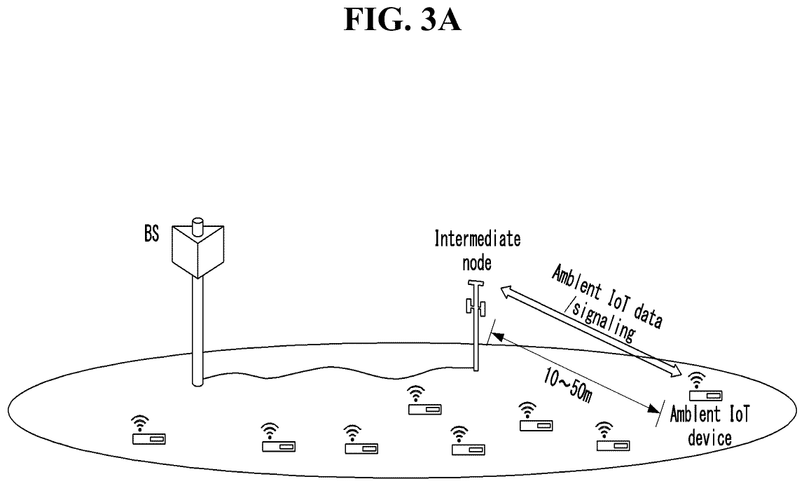

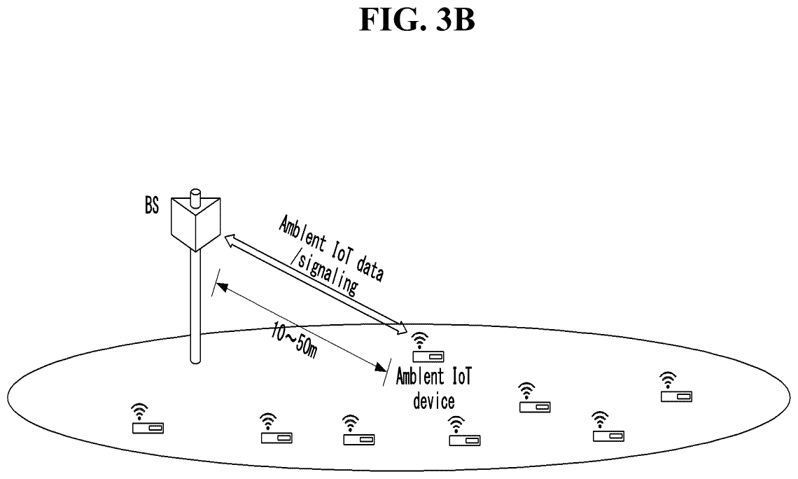

FIGS. 3A and 3B are conceptual diagrams illustrating two types of AIoT topologies being discussed in 3GPP.

Referring to FIG. 3A, topology 1 is illustrated in which a connection between indoors (AIoT device-intermediate node) and outdoors (base station (BS)-AIoT device) or vice versa is configured, and referring to FIG. 3B, topology 2 is illustrated for indoors in which a connection between a BS and an AIoT device is configured. Topology 2 is expected to be expanded from a terrestrial network to a non-terrestrial network in the future.

Since the Rel-19 AIoT device is a battery-less low-cost low-complexity device, phase distortion caused by hardware impairment may be severe, but a complex wireless transmission scheme for compensating for the phase distortion may be excluded. Therefore, in the standard meeting held in February 2024, it has been agreed to adopt a wireless transmission scheme that does not consider Forward Error-Correction Code (FEC) and channel estimation in a downlink case.

A conventional 5G New Radio (NR) wireless communication system is based on a Cyclic Prefix (CP)-Orthogonal Frequency Division Multiplexing (OFDM) transmission scheme that is robust to multi-path fading and superior in frequency efficiency. However, CP-OFDM has a disadvantage of having a high Peak-to-Average Power Ratio (PAPR), and thus high linearity of an amplifier is required, thereby increasing power consumption. In addition, there is a disadvantage that CP-OFDM is inherently not robust to phase distortion caused by hardware impairment such as Carrier Frequency Offset (CFO) and Phase Noise (PhN) and phase distortion caused by high mobility such as Doppler shift or Doppler spread. For this reason, a Single Carrier (SC) transmission scheme having no PAPR or very low PAPR may be used. However, conventional SC transmission schemes cannot be said to be very robust against phase distortion compared to CP-OFDM.

Recently, a Phase distortion-Resistant (PR)-SC transmission scheme that is inherently robust to phase distortion compared to CP-OFDM has been proposed. An example of this scheme may be expressed by Equation 1 below.

$$\begin{matrix}\begin{matrix}\breve{x} ( n ) = {e}^{j π {q}_{t} ( n )} , & 0 \leq n < N\end{matrix} \\ {q}_{t} ( n ) = m {\sum }_{{n}^{′} = 0}^{n} x ( {n}^{′} )\end{matrix} \qquad [ Equation 1 ]$$

In Equation 1, m denotes a scaling factor for eliminating an influence of phase ambiguity by making qₜ(n) formed between [−1,1). x(n′) corresponds to a symbol in a symbol block in the time domain excluding a CP, which is mentioned in SC-Frequency Domain Equalization (FDE).

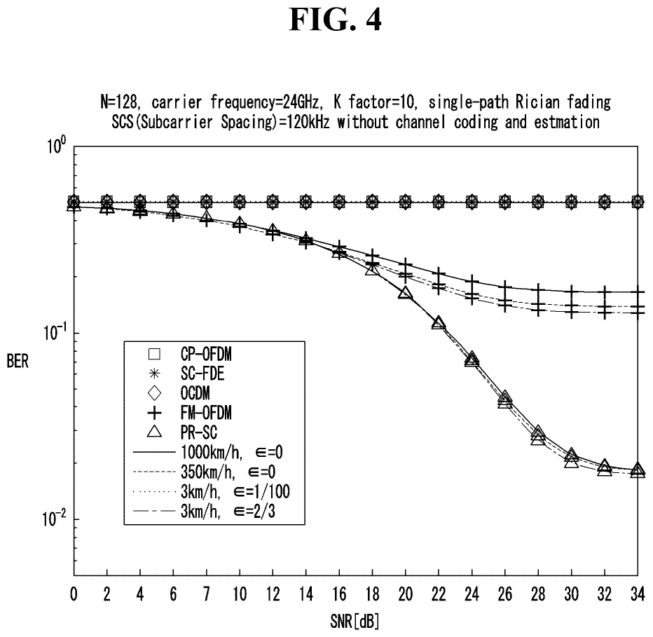

FIG. 4 is a graph comparing block error rate (BER) performances of the conventional transmission schemes and the PR-SC transmission scheme without channel coding/estimation.

Referring to FIG. 4, the PR-SC transmission scheme shows robustness against phase distortion compared to the conventional wireless transmission schemes such as Frequency Modulated-OFDM (FM-OFDM), Orthogonal Chirp Division Multiplexing (OCDM), SC-FDE, and CP-OFDM even though channel coding and channel estimation are not performed. As described in FIG. 3B, in order to expand AIoT topology 2 from a terrestrial network to a non-terrestrial network, a transmission scheme that realizes a communication range to a very long distance is required.

Therefore, it is necessary to develop a transmission scheme and an apparatus enabling communication up to a satellite in a non-terrestrial network from ground by maximizing diversity gain under time-domain symbols generated by applying a technique such as the above-mentioned PR-SC wireless scheme.

In the present disclosure, a wireless device is referred to as a Mobile Station (MS), and a device for transmitting a signal to the MS or receiving a signal of the MS is referred to as a Transmission and Reception Point (TRP). A device controlling the TRP is referred to as a Base Station (BS), and an area controlled by the BS is referred to as a cell. Therefore, hereinafter, specific methods and devices of the present disclosure are described based on a configuration of the MS, TRP, BS, and cell.

A BS may control a plurality of TRPs, and a plurality of MSs may exist in a cell controlled by the BS. However, for convenience of description, specific methods and devices of the present disclosure are described based on an example in which one BS controls one TRP and one MS exists within a cell. Meanwhile, uplink wireless transmission from the MS to the TRP may be performed. However, for convenience of description, only downlink wireless transmission from the TRP to the MS is described as an example in the present disclosure. However, any possible configuration corresponding to concepts of the wireless transmission method, signal design, transmission procedure, and device (hereinafter referred to as waveform technique) of the present disclosure described hereinafter may be included in a scope of the present disclosure.

The present disclosure proposes a PR-Repetitive Single Carrier (RSC) wireless transmission scheme as follows that may obtain diversity gain so that a wide communication range is achieved while having high resistance to phase distortion and zero PAPR.

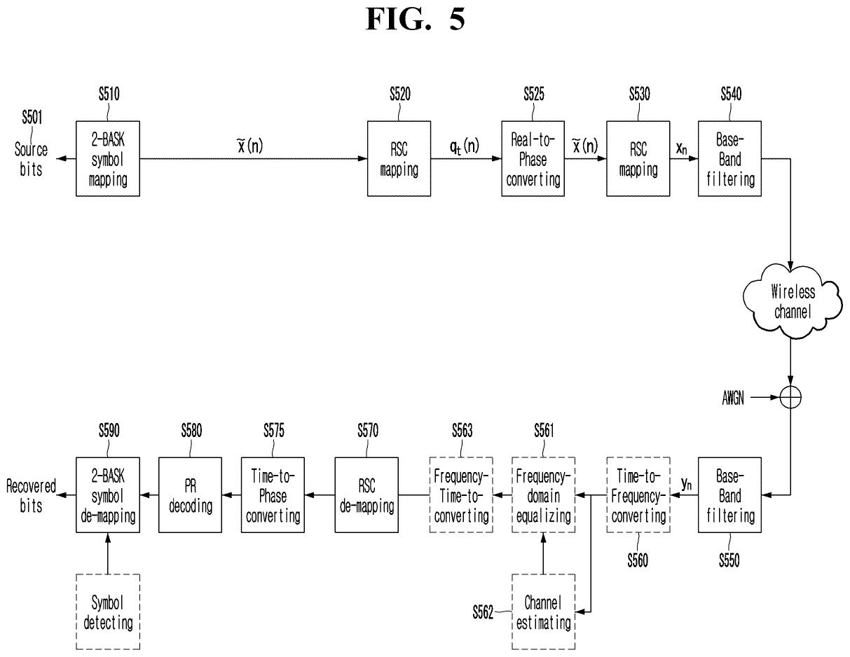

FIG. 5 is a block diagram illustrating a PR-RSC transmission scheme according to an exemplary embodiment of the present disclosure.

For convenience of description, in FIG. 5, operations (S501 to S540) at a transmitting side for a PR-RSC transmission scheme according to an exemplary embodiment of the present disclosure and operations (S550 to S590) at a receiving side corresponding thereto are illustrated together. In a downlink transmission case, the following operations (S501 to S540) are performed at a TRP, and the following operations (S550 to S590) may be performed at an MS. On the other hand, in an uplink transmission case, the following operations (S501 to S540) are performed at an MS, and the following operations (S550 to S590) may be performed at a TRP.

Referring to FIG. 5, a TRP may generate source bits to be transmitted to an MS (S501). Then, 2-Bipolar Amplitude Shift Keying (BASK) modulation may be performed on the generated source bits to generate a symbol sequence or a symbol block x̆(n) composed of elements having only integer components for n=0,1, . . . , N−1 (S510).

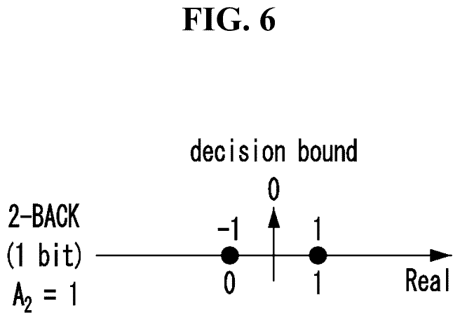

FIG. 6 is a conceptual diagram illustrating 2-BASK modulation according to an exemplary embodiment of the present disclosure.

Referring to FIG. 6, for each bit of the source bits, a bit having a value 0 may be mapped to an integer value −1, and a bit having a value 1 may be mapped to an integer value 1, so that each bit is mapped to an integer value to have an absolute magnitude A₂=1.

It should be noted here that 2-BASK is described as an example for convenience of description, and the present disclosure is not limited thereto, and all possible modulation schemes are included in a scope of the present disclosure. It should also be noted that, after the above mapping process, a process of adding a pilot may be performed, but a description of the process is omitted for convenience of description in the present disclosure.

In step S520, a PR encoding process may be performed on the symbol sequence x̆(n) so that a symbol sequence to be transmitted becomes inherently robust to phase distortion. A symbol sequence qₜ(n) obtained by performing the PR encoding on the symbol sequence x̆(n) may be expressed as in Equation 2 below.

$$\begin{matrix}{q}_{t} ( n ) = m π {\sum }_{{n}^{′} = 0}^{n} \breve{x} ( {n}^{′} ) , & 0 \leq n < N\end{matrix} \qquad [ Equation 2 ]$$

In Equation 2, m denotes a scaling factor for eliminating an influence of phase ambiguity by making qₜ(n) formed between [−π, π). N denotes the number of symbols constituting the first symbol sequence.

In step S525, real-to-phase converting may be performed on the symbol sequence qₜ(n) obtained by performing the PR encoding to generate a symbol sequence ñ (n). Step S525 may be expressed by Equation 3 below.

$$\begin{matrix}\tilde{x} ( n ) = {e}^{j {q}_{t} ( n )} = {e}^{j {ϕ}_{{d}_{n}}} , & 0 \leq n < N .\end{matrix} \qquad [ Equation 3 ]$$

In step S530, a Repetitive Single Carrier (RSC) encoding process may be performed on the symbol sequence \tilde{x}(n) having undergone the real-to-phase converting to generate a time-domain symbol sequence xₙ. Step S530 may be expressed by Equation 4 below.

$${x}_{n} = \{ \begin{matrix}{e}^{j ( {ϕ}_{{d}_{⌊ \frac{n}{A} ⌋}} )} , & even n = 0 , 2 , … , NA - 2 \\ {e}^{j ( - {ϕ}_{{d}_{⌊ \frac{n}{A} ⌋}} )} , & odd n = 1 , 3 , … , NA - 1.\end{matrix} \qquad [ Equation 4 ]$$

In Equation 4, φ_{z} indicates a phase component for a time-domain signal z, N indicates the total number of symbols constituting a symbol sequence, and A indicates a repetition factor. When A=1 is set, it indicates that repetition is not performed.

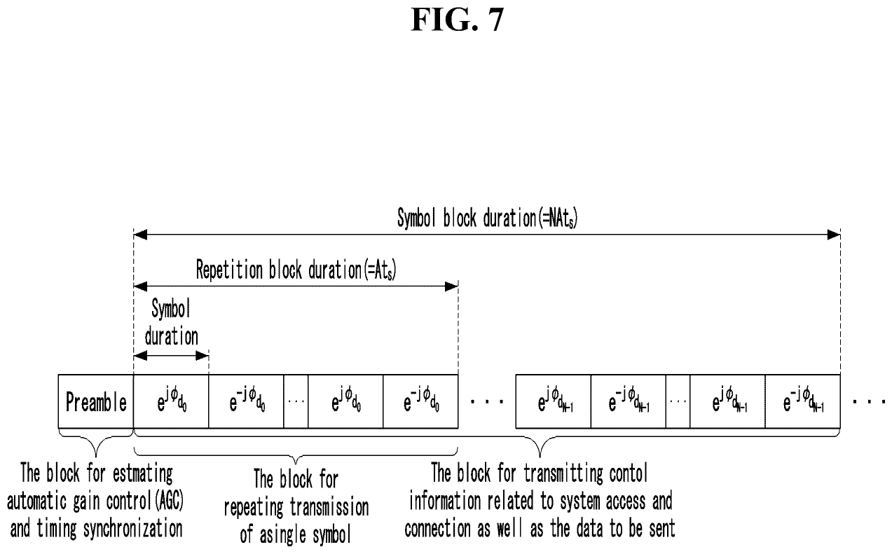

FIG. 7 is a conceptual diagram illustrating RSC encoding applied to the PR-RSC transmission method of the present disclosure.

Referring to FIG. 7, a preamble is required for Automatic Gain Control (ACG) and/or time/frequency synchronization. In FIG. 7, tₛ may denote a symbol time length.

The symbol sequence xₙ having undergone the RSC encoding of step S530 may be transmitted to a receiving side through a wireless channel after baseband filtering (S540), and baseband filtering may be performed again at the receiving side (S550).

Referring again to FIG. 5, in step S550, a baseband time-domain received symbol sequence yₙ corresponding to the symbol sequence xₙ may be expressed as in Equation 5 below.

$${y}_{n} = {w}_{n} + \sqrt{P} {α}_{{h}_{n}} \{ \begin{matrix}{e}^{j ( {ϕ}_{{d}_{⌊ \frac{n}{A} ⌋}} + {ϕ}_{{h}_{n}} + {ϕ}_{{ϵ}_{n}} )} , & even n = 0 , 2 , … , NA - 2 \\ {e}^{j ( - {ϕ}_{{d}_{⌊ \frac{n}{A} ⌋}} + {ϕ}_{{h}_{n}} + {ϕ}_{{ϵ}_{n}} )} , & odd n = 1 , 3 , … , NA - 1.\end{matrix} \qquad [ Equation 5 ]$$

In Equation 5, P denotes a received power, α_{z} denotes an amplitude component for a signal z, and hₙ denotes a wireless fading channel, and for convenience of description, the present disclosure assumes a single-path Doppler shift for hₙ·ϵₙ denotes a carrier frequency offset (CFO), wₙ denotes noise, and y* denotes a conjugated complex of a signal y, which may be a signal that takes a real component of y as it is and inverts a polarity of an imaginary component thereof.

After step S550, processes of channel estimation and compensation thereof, that is, time-to-frequency converting (S560), frequency-domain equalizing (S561), channel estimating (S562), and frequency-to-time converting (S563), may be performed on the received symbol sequence yₙ. Since the above processes correspond to operations of a general receiver, descriptions of steps S560 to S563 are omitted for convenience of description.

In step S570, RSC de-mapping may be performed on the received symbol sequence yₙ.

In the RSC de-mapping process, combination between adjacent symbols may be performed as in Equation 6 below.

$${\breve{y}}_{{n}^{′}} = {( {y}_{2 {n}^{′} + 1} )}^{*} + {y}_{2 {n}^{′}} = ( {w}_{2 {n}^{′} + 1}^{*} + {w}_{2 {n}^{′}} ) + \sqrt{P} ( \begin{matrix}{α}_{{h}_{2 {n}^{′} + 1}} {e}^{j ( - {ϕ}_{{h}_{2 {n}^{′} + 1}} - {ϕ}_{{ϵ}_{2 {n}^{′} + 1}} )} + \\ {α}_{{h}_{2 {n}^{′}}} {e}^{j ( - {ϕ}_{{h}_{2 {n}^{′}}} - {ϕ}_{{ϵ}_{2 {n}^{′}}} )}\end{matrix} ) {e}^{j ( {ϕ}_{{d}_{⌊ \frac{2 {n}^{′}}{A} ⌋}} )} , \qquad [ Equation 6 ]$$

$${n}^{′} = 0 , 1 , … , ⌊ \frac{N A - 1}{2} ⌋ .$$

In Equation 6, assuming αₕ_{_{2n′+1}}≈αₕ_{_{2n′}}, φₕ_{_{2n′+1}}≈φₕ_{_{2n′}}, and φϵ₂_{_{n′+1}}≈φ_{ϵ}_{_{2n′}}, y̆(n′) may be re-expressed as in Equation 7 below.

$${\breve{y}}_{{n}^{′}} \approx \sqrt{P} {α}_{{h}_{2 {n}^{′}}} cos ( {ϕ}_{{h}_{2 {n}^{′}}} + {ϕ}_{{ϵ}_{2 {n}^{′}}} ) exp \{ j {ϕ}_{{d}_{⌊ \frac{2 {n}^{′}}{A} ⌋}} + ( {w}_{2 {n}^{′} + 1}^{*} + {w}_{2 {n}^{′}} ) . \qquad [ Equation 7 ]$$

In step S570, up to 3 dB of Signal to Noise Ratio (SNR) gain may be obtained. When a symbol sequence (i.e. a repetition-removed symbol sequence) is generated through the final RSC de-mapping process such that the number of symbols corresponds to the number of symbols of the symbol sequence after symbol mapping at the transmitting side, the symbol sequence may be expressed as in Equation 8 below.

$${\tilde{y}}_{{n}^{″}} = \frac{1}{A} {\sum }_{a = 0}^{⌊ \frac{A}{2} ⌋ - 1} {\breve{y}}_{{n}^{″} ⌊ \frac{A}{2} ⌋ + a} \approx \sqrt{P} {α}_{{h}_{{n}^{″}}} cos ( {ϕ}_{{h}_{{n}^{″}}} + {ϕ}_{{ϵ}_{{n}^{″}}} ) {e}^{j ( {ϕ}_{{d}_{{n}^{″}}} )} , {n}^{″} = 0 , 1 , … , N - 1 \qquad [ Equation 8 ]$$

$${\hat{y}}_{{n}^{″}} = {tan}^{- 1} {\tilde{y}}_{{n}^{″}} or atan 2 ( imag ( {\tilde{y}}_{{n}^{″}} ) , real ( {\tilde{y}}_{{n}^{″}} ) ) .$$

In Equation 8, imag (\tilde{y}(n″)) and real (\tilde{y}(n″)) respectively indicate an imaginary component and a real component of ŷ(n″). In a process of Equation 8 above, up to 10 log ((A+2)/2) dB of SNR gain may be obtained. In addition, for convenience of description, a description of a time-to-phase converting process S575 which follows the RSC de-mapping process is omitted. That is, step S585 corresponds to an operation of step S525 at the transmitting side.

In step S580, an inverse process corresponding to the PR encoding process at the transmitting side, that is, a PR decoding process, may be performed. In step S580, the PR decoding may be performed as in Equation 9 below.

$${\hat{ϕ}}_{{d}_{n}} = {\hat{q}}_{t} ( n ) = ( {\hat{y}}_{{n}^{″}} - {\hat{y}}_{{( n - 1 )}^{″}} ) , 0 \leq n < N \qquad [ Equation 9 ]$$

$${\hat{y}}_{{( - 1 )}^{″}} = 0$$

Then, an input symbol sequence for 2-BASK symbol de-mapping may be generated as in Equation 10 below by eliminating influences of the scaling factor and the value of π.

$$\hat{\breve{x}} ( n ) = \frac{1}{m π} {q}_{t} ( n ) \qquad [ Equation 10 ]$$

Finally, in step S590, a restored source bit sequence may be generated through a 2-BASK symbol de-mapping process. For example, as an inverse operation of the symbol mapping process in FIG. 6, when \hat{x}(n) is positive, the symbol may be de-mapped to a bit value ‘1’, and when \hat{x}(n) is negative, the symbol may be de-mapped to a bit value ‘0’.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A signal transmission method comprising:
generating a first symbol sequence from a source bit sequence;
performing phase distortion-resistant (PR) encoding on the first symbol sequence to generate a second symbol sequence;
performing real-to-phase converting on the second symbol sequence to generate a third symbol sequence;
performing repetitive single carrier (RSC) encoding on the third symbol sequence to generate a fourth symbol sequence; and
performing baseband filtering on the fourth symbol sequence and transmitting the baseband-filtered fourth symbol sequence over a wireless channel.

2. The signal transmission method of claim 1, wherein the generating of the first symbol sequence comprises: mapping each bit of the source bit sequence to an integer value of −1 or 1 such that absolute magnitudes of symbols of the first symbol sequence are identical.

3. The signal transmission method of claim 1, wherein the PR encoding is expressed by:
$${q}_{t} ( n ) = m π {\sum }_{{n}^{′} = 0}^{n} \breve{x} ( {n}^{′} ) , 0 \leq n < N$$
wherein the first symbol sequence is x̆(n), the second symbol sequence is qₜ(n), m denotes a scaling factor to form qₜ(n) within [−π, π), and N denotes a number of symbols included in the first symbol sequence.

4. The signal transmission method of claim 3, wherein the real-to-phase converting is expressed by:
$$x ( n ) = {e}^{{jq}_{t} ( n )} , 0 \leq n < N$$
wherein the third symbol sequence is \tilde{x}(n).

5. The signal transmission method of claim 4, wherein the RSC encoding is expressed by:
$${x}_{n} = \{ \begin{matrix}{e}^{j ( {ϕ}_{{d}_{⌊ \frac{n}{A} ⌋}} )} , even n = 0 , 2 , … , NA - 2 \\ {e}^{j ( - {ϕ}_{{d}_{⌊ \frac{n}{A} ⌋}} )} , odd n = 1 , 3 , … , NA - 1\end{matrix}$$
where the fourth symbol sequence is xₙ, φ_{z} denotes a phase component of a time-domain signal z, N denotes a number of symbols included in the fourth symbol sequence, and A denotes a repetition factor.

6. A signal reception method comprising:
performing baseband filtering on a received signal to generate a first symbol sequence;
performing repetitive single carrier (RSC) de-mapping on the first symbol sequence to generate a second symbol sequence;
performing time-to-phase converting on the second symbol sequence to generate a third symbol sequence;
performing phase distortion-resistant (PR) decoding on the third symbol sequence to generate a fourth symbol sequence; and
generating a restored source bit sequence from the fourth symbol sequence.

7. The signal reception method of claim 6, further comprising: performing time-to-frequency converting, frequency-domain equalizing, and frequency-to-time converting on the first symbol sequence.

8. The signal reception method of claim 6, wherein the first symbol sequence is expressed as a time-domain signal according to:
$${y}_{n} = {w}_{n} + \sqrt{P} {α}_{{h}_{n}} \{ \begin{matrix}{e}^{j ( {ϕ}_{{d}_{⌊ \frac{2 n}{A} ⌋}} + {ϕ}_{{h}_{n}} + {ϕ}_{{ϵ}_{n}} )} , even n = 0 , 2 , … , NA - 2 \\ {e}^{j ( - {ϕ}_{{d}_{⌊ \frac{2 n}{A} ⌋}} + {ϕ}_{{h}_{n}} + {ϕ}_{{ϵ}_{n}} )} , odd n = 1 , 3 , … , NA - 1\end{matrix}$$
where P denotes A received power, φ_{z} denotes a phase component of a time-domain signal z, α_{z} denotes an amplitude component of the signal z, hₙ denotes a wireless fading channel, ϵₙ denotes a carrier frequency offset (CFO), wₙ denotes noise, N denotes a number of symbols included in the second symbol sequence, and A denotes a repetition factor.

9. The signal reception method of claim 8, wherein the RSC de-mapping is expressed by:
$${\breve{y}}_{{n}^{′}} = {( {y}_{2 {n}^{′} + 1} )}^{*} + {y}_{2 {n}^{′}} = ( {w}_{2 {n}^{′} + 1}^{*} + {w}_{2 {n}^{′}} ) + \sqrt{P} ( \begin{matrix}{α}_{{h}_{2 {n}^{′} + 1}} {e}^{j ( - {ϕ}_{{h}_{2 {n}^{′} + 1} - {ϕ}_{{ϵ}_{2 {n}^{′} + 1}}} )} \\ + {α}_{{h}_{2 {n}^{′}}} {e}^{j ( {ϕ}_{{h}_{2 {n}^{′}} + {ϕ}_{{ϵ}_{2 {n}^{′}}}} )}\end{matrix} ) {e}^{j ( {ϕ}_{{d}_{⌊ \frac{2 {n}^{′}}{A} ⌋}} )} ,$$
$${n}^{′} = 0 , 1 , , ⌊ \frac{NA - 1}{2} ⌋$$
where y̆(n′) is the second symbol sequence, and y* denotes a complex conjugate of y in which a real part remains unchanged and an imaginary part is polarity-reversed.

10. The signal reception method of claim 9, wherein the second symbol sequence is approximated as:
$${\breve{y}}_{{n}^{′}} \approx \sqrt{P} {α}_{{h}_{2 {n}^{′}}} cos ( {ϕ}_{{h}_{2 {n}^{′}}} + {ϕ}_{{ϵ}_{2 {n}^{′}}} ) exp \{ j {ϕ}_{{d}_{⌊ \frac{2 {n}^{′}}{A} ⌋}} + ( {w}_{2 {n}^{′} + 1}^{*} + {w}_{2 {n}^{′}} ) .$$
under assumptions of αₕ_{_{2n′+1}}≈αₕ_{_{2n′}}, φₕ_{_{2n′+1}}≈φₕ_{_{2n′+1}}, φ_{ϵ}_{_{2n′+1}}≈φ_{ϵ}_{_{2n′}}.

11. The signal reception method of claim 10, wherein a symbol sequence from which repetition has been removed in the second symbol sequence is expressed by:
$${\tilde{y}}_{{n}^{″}} = \frac{1}{A} {\sum }_{a = 0}^{⌊ \frac{A}{2} ⌋ - 1} {\breve{y}}_{{n}^{″} ⌊ \frac{A}{2} ⌋ + a} \approx \sqrt{P} {α}_{{h}_{{n}^{″}}} cos ( {ϕ}_{{h}_{{n}^{″}}} + {ϕ}_{{ϵ}_{{n}^{″}}} ) {e}^{j ( {ϕ}_{{d}_{{n}^{″}}} )} , {n}^{″} = 0 , 1 , … , N - 1$$
$${\hat{y}}_{{n}^{″}} = {tan}^{- 1} {\tilde{y}}_{{n}^{″}} or atan 2 ( imag ( {\tilde{y}}_{{n}^{″}} ) , real ( {\tilde{y}}_{{n}^{″}} ) )$$
wherein imag(\tilde{y}(n″)) and real(\tilde{y}(n″)) respectively denote imaginary and real components of ŷ(n″).

12. The signal reception method of claim 11, wherein the PR decoding process is expressed by:
$${\hat{q}}_{t} ( n ) = ( {\hat{y}}_{{n}^{″}} - {\hat{y}}_{{( n - 1 )}^{″}} ) , 0 \leq n < N$$
$${\hat{y}}_{{( - 1 )}^{″}} = 0$$
$$\hat{\breve{x}} ( n ) = \frac{1}{m π} {\hat{q}}_{t} ( n )$$
wherein the fourth symbol sequence is x̆(n).

13. The signal reception method of claim 6, wherein the generating of the restored source bit sequence comprises mapping each symbol of the fourth symbol sequence to a bit value 1 or 0.

14. A signal transmission apparatus comprising at least one processor, wherein the at least one processor causes the signal transmission apparatus to perform:
generating a first symbol sequence from a source bit sequence;
performing phase distortion-resistant (PR) encoding on the first symbol sequence to generate a second symbol sequence;
performing real-to-phase converting on the second symbol sequence to generate a third symbol sequence;
performing repetitive single carrier (RSC) encoding on the third symbol sequence to generate a fourth symbol sequence; and
performing baseband filtering on the fourth symbol sequence and transmitting the baseband-filtered fourth symbol sequence over a wireless channel.

15. The signal transmission apparatus of claim 14, wherein in the generating of the first symbol sequence, each bit of the source bit sequence is mapped to an integer value of −1 or 1 such that absolute magnitudes of symbols of the first symbol sequence are identical.

16. The signal transmission apparatus of claim 14, wherein the PR encoding is expressed by:
$${q}_{t} ( n ) = m π {\sum }_{{n}^{′} = 0}^{n} \breve{x} ( {n}^{′} ) , 0 \leq n < N$$
wherein the first symbol sequence is x̆(n), the second symbol sequence is qₜ(n), m denotes a scaling factor to form qₜ(n) within [−π, π), and N denotes a number of symbols included in the first symbol sequence.

17. The signal transmission apparatus of claim 16, wherein the real-to-phase converting is expressed by:
$$\tilde{x} ( n ) = {e}^{{jq}_{t} ( n )} , 0 \leq n < N$$
wherein the third symbol sequence is \tilde{x}(n).

18. The signal transmission apparatus of claim 17, wherein the RSC encoding is expressed by:
$${x}_{n} = \{ \begin{matrix}{e}^{j ( {ϕ}_{{d}_{⌊ \frac{n}{A} ⌋}} )} , even n = 0 , 2 , … , NA - 2 \\ {e}^{j ( - {ϕ}_{{d}_{⌊ \frac{n}{A} ⌋}} )} , odd n = 1 , 3 , … , NA - 1\end{matrix}$$
where the fourth symbol sequence is xₙ, φ_{z} denotes a phase component of a time-domain signal z, N denotes a number of symbols included in the fourth symbol sequence, and A denotes a repetition factor.
